(19) United States
(12) Patent Application Publication
(10) Pub. No.: US 2014/0116515 A1
(43) Pub. Date: May 1, 2014

(54) FLUID DISPENSING SYSTEM WITH BREAK-AWAY COUPLING

(71) Applicant: Macro Technologies, LLC, Kirkland, WA (US)

(72) Inventor: Howard M. KONISHI, Kirkland, WA (US)

(73) Assignee: Macro Technologies, LLC, Kirkland, WA (US)

(21) Appl. No.: 14/061,487

(22) Filed: Oct. 23, 2013

Related U.S. Application Data
(60) Provisional application No. 61/717,597, filed on Oct. 23, 2012.

(51) Int. Cl. F16L 55/10

(52) U.S. Cl. CPC F16L 55/1015
USPC 137/1; 137/469; 285/1

(57) ABSTRACT

A break-away coupling within a fuel dispensing line configured to arrest the flow of fluid when broken away. The coupling includes a first end configured to engage a fluid dispensing nozzle and a second end configured to engage a fluid dispensing system. Then, a break-away body is disposed between the first end and the second end and the coupling includes a sensor configured to determine if the first end is separated from the second end in any manner. Such a separation may be caused by a large force applied to one end, such as a truck driving away with the fueling nozzle will engaged in the fuel talk. Thus, upon separation at the break-away point, the sensor may trigger a shut-off procedure at the fuel dispensing system.

### PRIORITY CLAIM

The instant application claims priority to U.S. Provisional Patent Application Ser. No. 61/717,597, filed Oct. 23, 2012, which application is incorporated herein by reference in its entirety.

### BACKGROUND

During vehicular fueling, a “drive away” incident may occur. A vehicle may have a fuelling nozzle coupled with or inserted into a vehicle with fuel flowing from a dispenser to the vehicle and into its fuel tank. Unfortunately, it is not uncommon for absent-minded drivers to drive away from the dispenser with the nozzle still remaining attached to the vehicle. This presents a dangerous situation because unless the nozzle detaches from the vehicle, a portion of the fueling line and dispenser or vehicle components may break or may be damaged as the vehicle drives away. In addition to causing damage to expensive components, fuel may be rapidly released into the environment.

A fuel release creates a risk of explosions in the case of combustible fuels, and cryogenic fuels create the hazard of freezing temperatures along with possible combustion. Moreover, the fuel dispenser may continue to pump fuel through broken portions of the fuel dispenser system, and it may be difficult to stop the escape of fuel.

Various break-away couplings exist in the art that provide a point within a fuel delivery system that will fail before other portions of the system fail. While some break-away couplings can stop the leak of fuel out of the failure point of the fuel dispenser system, this may not provide a safe resolution to the drive-away incident. For example, where fuel continues to be pumped through the system, dangerous pressure may result on the dispensing side despite a leak stop valve or the like. Likewise, any fluid that remains in the nozzle side of the system after a break-away may also be trapped and subsequently expand due to ambient temperature increases over time. Further, an explosive failure of the system may occur, which may be more dangerous than a simple leaking break in the fuel dispensing system.

### BRIEF DESCRIPTION OF THE DRAWINGS

The present subject matter disclosure will be described by way of exemplary embodiments but not limitations, illustrated in the accompanying drawings in which like references denote similar elements, and in which:

FIG. 1a is a close-up side view of a fuel dispensing system having a break-away coupling in accordance with one embodiment.

FIG. 1b is a side view of a fuel dispensing system having a break-away coupling in accordance with one embodiment.

FIG. 1c is a perspective view of a break-away coupling in accordance with another embodiment.

FIG. 2 is a cross section of a break-away coupling in accordance with a further embodiment.

FIG. 3a is a close-up cross section of the break-away coupling in accordance with the embodiment of FIG. 2.

FIG. 3b is a close-up cross section of the break-away coupling in accordance with the embodiment of FIG. 2 with a broken break-away body and extended poppets.

### DETAILED DESCRIPTION

Illustrative embodiments presented herein include, but are not limited to, systems and methods for providing a rapid-connect gas coupler.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

By way of overview, an embodiment herein includes a break-away coupling within a fuel dispensing line configured to arrest the flow of fluid when broken away. Thus, the coupling includes a first end configured to engage a fluid dispensing nozzle and a second end configured to engage a fluid dispensing system. Then, a break-away body is disposed between the first end and the second end and the coupling includes a sensor configured to determine if the first end is separated from the second end in any manner. Such a separation may be caused by a large force applied to one end, such as a truck driving away with the fueling nozzle will engaged in the fuel talk. Thus, upon separation at the break-away point, the sensor may trigger a shut-off procedure at the fuel dispensing system.

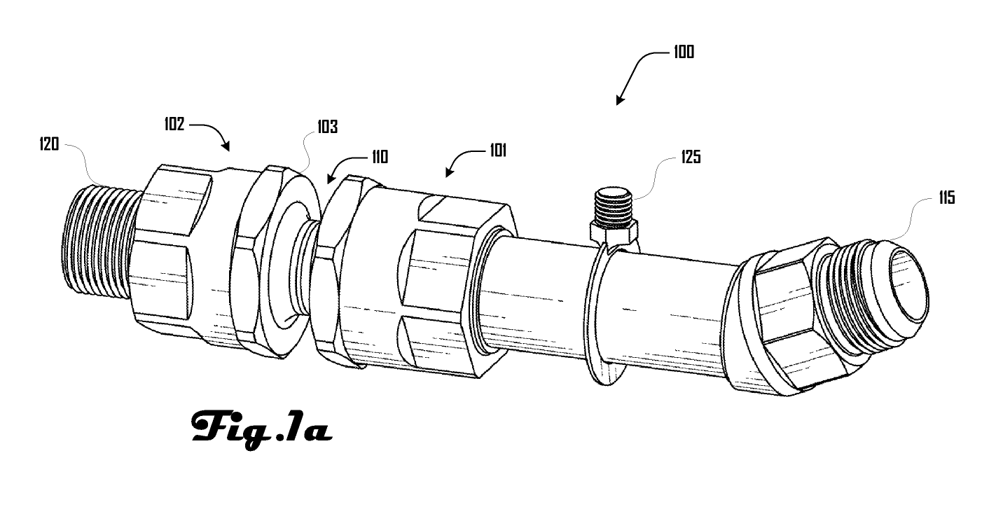

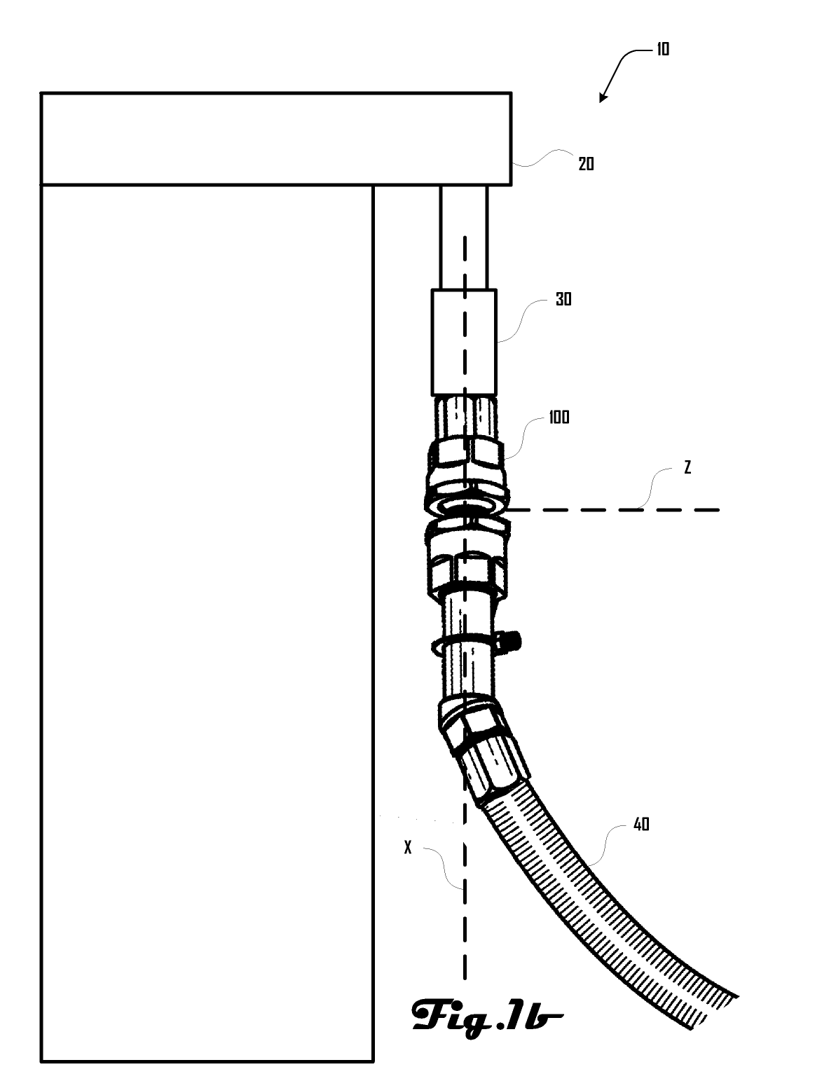

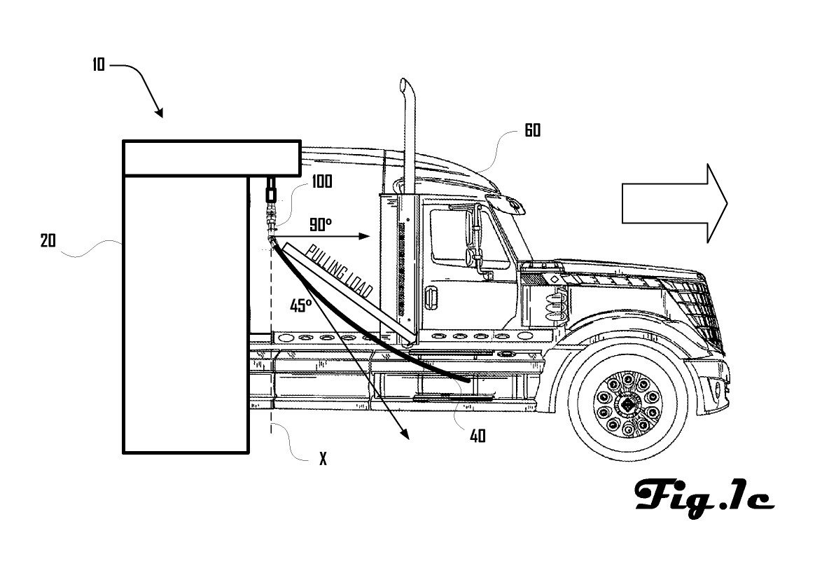

In embodiments, the break-away body comprises a junction point of a first portion and a second portion suited to break when a suitable force is applied to the junction. The sensor comprises a pressure sensor, electric sensor or mechanical pin suited to provide a signal indicating coupling of the first end to the second end. Further, after separation, poppets may close each end after separation to assist with controlling flow of the fluids. Further yet, the nozzle end may also include two shafts angled with respect to each other wherein a first shaft having a first central axis is aligned with a central axis of the first end; and a second shaft having a second central axis is set at a non-zero angle with respect to the first central axis. These and other aspects will become more apparent below when each embodiment is discussed in detail with respect to FIGS. 1-3.

FIG. 1a is a perspective view of a break-away coupling 100 in accordance with an embodiment. The break-away coupling 100 may comprise a nozzle-side architecture 101 and a dispenser-side architecture 102 that are joined by a break-away body 103 that comprises a break-away slot 110. The break-away coupling 100 may extend from a nozzle end 115 to a dispenser end 120. The break-away coupling 100 may further comprises a sensor plug 125 coupled to the nozzle-side architecture 101.

In various embodiments, and referring to FIG. 1b and FIG. 1c, the break-away coupling 100, in accordance with one embodiment may be disposed within a portion of a fueling line of a fuel-delivery system 10. For example, a dispenser-side fitting 30 may extend from a fuel dispenser 20 and couple with the break-away coupling 100 at the dispenser end 120 of the dispenser-side architecture 102. A nozzle-end hose 40 may be coupled to the nozzle-end architecture 101 at the nozzle end 115 and extend to a fueling nozzle (not shown) at a terminal end of the nozzle-end hose 40. Fuel may flow from the dispenser 20, through the break-away coupling 100, and out the nozzle to facilitate vehicle fueling.

In an embodiment, and as discussed in further detail herein, the coupler 100 may be configured to break or fail in response to a drive-away incident. For example, as depicted in FIG. 1c, during vehicle refueling, a fuel delivery system 10 may be coupled to a vehicle 60 and fuel may be flowing from a fuel dispenser 20 to the vehicle 60. If the vehicle 60 begins to move away from the fuel dispenser system 10, various portions of the fuel-delivery system 10 may be at risk of substantial damage and excessive fuel may be released into the into the environment if a portion of the fuel-delivery system 10 fails or breaks.

Accordingly, the break-away coupling 100 may be configured to fail before other portions of a fuel delivery system 10 and may be further configured to limit, prevent, or stop the release of fuel into the environment. For example, as discussed herein, the break-away body 103 may be configured to fail at desired load point at a break axis Z, which is perpendicular to a coupler body axis X. In some embodiments, and referring to FIG. 1c, a fuel delivery system 10 having a break-away coupling 100 may be configured to break away when a pulling load is incident at about 45° to 90° from the coupler body axis X.

Additionally, a break-away coupling 100 may be mounted, positioned or configured in other ways in a fuel-delivery system 10. For example, while FIG. 1c depicts a fuel-delivery system 10 wherein a dispenser-side fitting 30 extends downward with a break-away coupling 100 attached thereto and further extending downward, in some embodiments, a dispenser-side fitting 30 may extend upward with a break-away coupling 100 attached thereto with the break-away coupling 100 further extending upward.

In an embodiment, the break-away coupling 100 may be used in liquid natural gas (“LNG”) re-fueling applications. Accordingly, the break-away coupling 100 may be configured to operate under cryogenic temperatures of about −200° F., −260° F., −300° F. or the like. The break-away coupling 100 may be further configured to operate at flow rates of about 10, 50, 100, 200, 400 gallons per minute (“GPM”), or the like. While various embodiments are described herein in relation to fuel dispensing and portions of a fuel-delivery system 10, alternative embodiments may be used in and configured for various types of fluids, at various temperatures, with various applications. Accordingly, the present disclosure should not be construed to limit the break-away coupling 100 to the example embodiments disclosed herein.

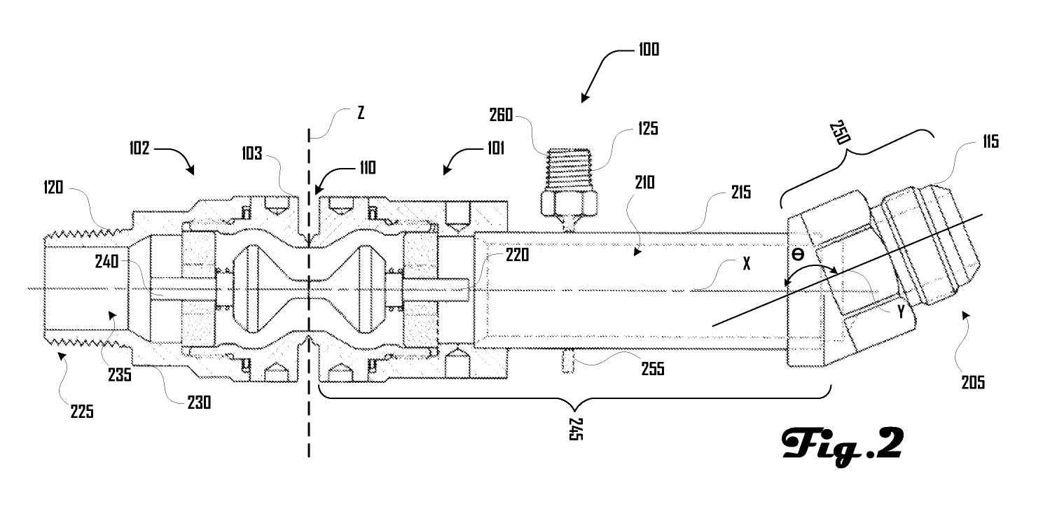

FIG. 2 is a cross section of a break-away coupling 100 in accordance with an embodiment. The break-away coupling 100 may comprise a nozzle side architecture 101 that extends from a nozzle-end 115 that includes a nozzle-end coupling portion 205. The nozzle side architecture 101 further includes a nozzle-side cavity 201 defined by a nozzle-side housing 215. A nozzle-side poppet 220 is also disposed in the nozzle-side housing 215. A nozzle (not shown) or nozzle hose 40 may couple to the nozzle-side architecture 101 at the nozzle-end 115 at a nozzle-coupling portion 205.

The break-away coupling 100 may further comprise a dispenser-side architecture 102 that couples with a fuel dispenser 20 or fuel dispenser fitting 30 at a dispenser end 120 having a dispenser coupling portion 225. A dispenser-side housing 230 defines a dispenser-side cavity 235 and a dispenser-side poppet 240 is disposed within the dispenser-side housing 230.

In various embodiments, it may be desirable for one or more portions of the break-away coupling 100 to be absent or modified so that a user may select fittings and couplings for use with the break-away coupling 100. For example, in one embodiment, the nozzle-end coupling portion 205 may be blank so that a user may weld a desired fitting at the nozzle end 115. Similarly, the dispenser end 120 may also be blank in some embodiments.

The nozzle-side architecture 101 and dispenser-side architecture 102 may be coupled by the break-away body 103, which comprises a break-axis Z, which may be perpendicular to axis X.

The nozzle-side architecture 101 may further comprise a first shaft portion 245, which is aligned with axis X. The dispenser-side architecture 102 may also be aligned with axis X as depicted in FIG. 2. The nozzle-side architecture 101 may further comprise a second shaft portion 250, which is aligned with axis Y. Axes X and Y may be relative to each other at an angle θ. In various embodiments, angle θ may be any suitable angle including, but not limited to about, 90°, 120°, 150°, 180° or any other suitable angle.

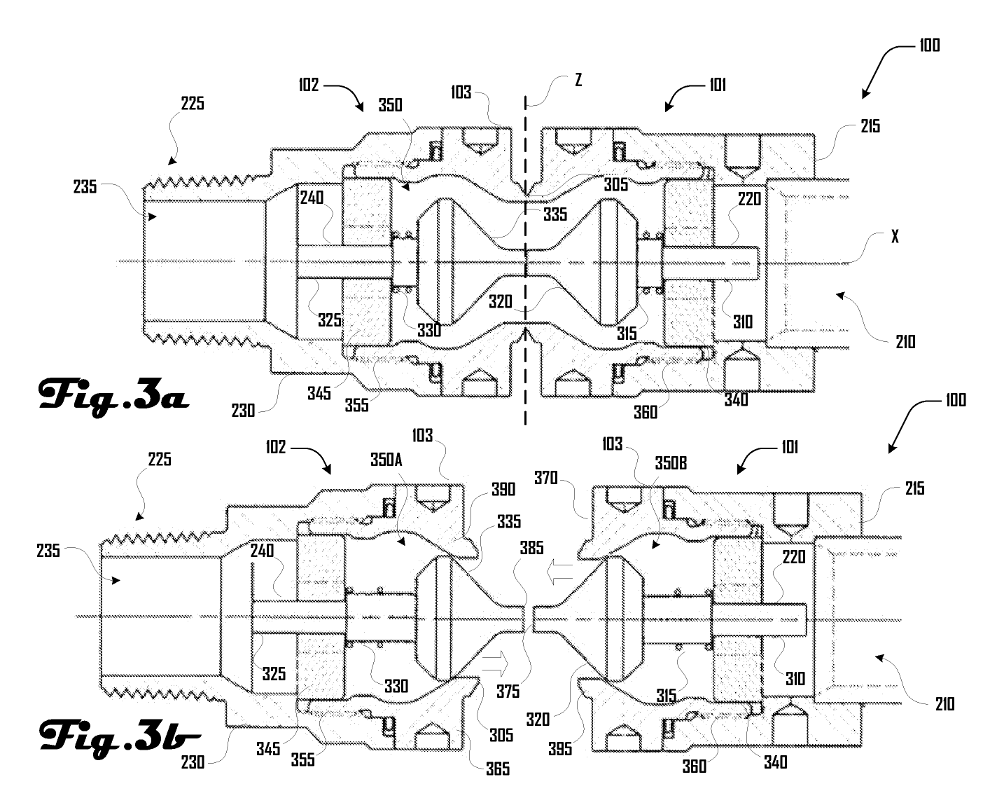

In an embodiment, it may be desirable for the first and second shaft portion 245, 250 to be disposed at an angle such that axes X and Y are not parallel so that if force is applied to the break-away coupling 100 from the nozzle and dispenser ends 115, 120 (e.g., during drive-away incident), a shearing force may be applied to the break-away body 103 instead of a force that is substantially parallel to axis X or perpendicular to break-axis Z. Such a shearing force may be desirable because the break-away body 103 may be designed to fail or break at a desired shear threshold and calibrating such a shear threshold may be easier than calibrating a break threshold when a breaking force is primarily applied perpendicular to the break-axis Z or parallel to the axis X. Additionally, in some embodiments a break generated by a shear force may provide for a clean break or failure instead of only a partial failure of the break-away body 103. Breaking or failure of the break-away body 103 is described in more detail in relation to FIGS. 3a and 3b.

The break-away coupling 100 may further include a sensor plug 125 that includes a ring 255 and plug head 260. The ring 255 may encircle the nozzle-side architecture 101 and support the plug head 260, which may be threaded. In an embodiment, pneumatic tubing (not shown) from a pressure switch (not shown) associated with a fuel-delivery system 10 may be coupled with the plug head 260. The pressure switch may be activated in the event of a drive-away where the nozzle side architecture 101 and dispenser size architecture 120 break apart.

For example, in a drive away incident, the break-away body 103 may fail and allow the nozzle-side architecture 101 to travel with the nozzle (not shown) and/or nozzle-side hose 40 that remains in the drive-away vehicle. Pneumatic tubing coupled to the plug head 260 would be sheared off the sensor plug 125 and trip a pressure switch (not shown) and trigger an emergency shutoff of the fuel delivery system 10. This may provide for prevention of or reduction of fuel release into the environment as a result of the break-away coupling 100.

In one embodiment, an emergency shutoff may be achieved during a drive-away incident in other ways. For example, the sensor plug 125 may be coupled to a line that pulls a pin, button or lever to initiate a dispenser shutoff. In some embodiments, there may be a structure that mechanically or electronically senses when the nozzle-side architecture 101 and dispenser-side architecture 102 have separated and/or when the break-away body 103 breaks.

FIG. 3a is a close-up cross section view of the break-away coupling 100 in accordance with the embodiment of FIG. 2. Further, FIG. 3b is a close-up cross section view of the break-away coupling 100 with a broken break-away body 103.

As discussed herein, the break-away body 103 may be configured to break or fail at a failure point 305. The failure point 305 may be configured to fail along break axis Z. In an embodiment, the failure point 305 may be a thin section of a contiguous break-away body 103, which is configured to break or fail at a desired point. In some embodiments, the failure point 305 may comprise a weld, adhesive, magnet, friction fitting or other suitable coupling that is configured to fail at a desired point.

When the break-away body 103 is intact as depicted in FIG. 3a fluid may be configured to flow through the break-away coupling 100 via the a dispenser-side cavity 235, a break-away cavity 350 and the nozzle-side cavity 210. The nozzle-side poppet 220 and dispenser side poppet 240 may be in a compressed position as shown in FIG. 3a and may assume an extended position as depicted in FIG. 3b when the break-away body 103 is broken.

The nozzle-side poppet 220 may comprise a nozzle-side poppet shaft 310, a nozzle-side poppet spring 315, and a nozzle-side poppet head 320. The dispenser-side poppet 240 may comprise a dispenser-side poppet shaft 325, a dispenser-side poppet spring 330, and a dispenser-side poppet head 335. A nozzle-side and dispenser-side poppet support 340, 345 may support each respective poppet 220, 240.

The poppet heads 320, 335 may be slidably biased on the respective poppet shafts 310, 325 by the respective poppet springs 315, 330. The poppets 220, 240 may face each other and interface at respective poppet tips 375, 380 such that the poppets 220, 240 are compressed within the break-away cavity 350.

When the break-away body 103 fails about the failure point 305, the poppets 220, 240 extend into the configuration depicted in FIG. 3b such that the poppet heads 320, 335 are forced against respective cavity lips 390, 395 and thereby block respective break-away cavity portions 350A, 350B.

In an embodiment, the extended configuration of poppets 220, 240 stops fluid from escaping from the separated nozzle-side architecture 101 and dispenser side architecture 102. Accordingly, when the break-away body 103 fails, the release of fluid from the coupler may be prevented or reduced when the nozzle-side architecture 101 and dispenser side architecture 102 are sealed by the respective poppets 220, 240.

In an embodiment, one or more of the poppets 220, 240 may be configured allow a controlled leak of fluid. For example, in the context of a fluid delivery system 10 (FIG. 1b and FIG. 1c), when the break-away body 103 fails, the dispenser-side architecture 102 and dispenser-fitting 30 may remain pressurized because the fuel dispenser 20 may continue to pump fuel. To prevent over-pressurization of the dispenser-side architecture 102 and dispenser-fitting 30 (which may lead to explosive failure of these components), the dispenser side poppet 240 may be configured to allow a controlled release of fluid.

In some embodiments that utilize fluids that have a normal temperature close to an ambient temperature, the nozzle-side poppet 220 may substantially seal the nozzle-side architecture 101 without a controlled leak. For example, in the context of a fuel delivery system 10, the nozzle-side hose 40 and nozzle (not shown) may be pressurized, but may not experience increased pressurization as with the dispenser-side fitting 30 (e.g., due to continued fuel pumping by the fuel dispenser 20). Accordingly, a controlled leak via the nozzle-side poppet 220 may not be necessary to prevent over-pressurization of the nozzle-side hose 40, nozzle-side architecture 101 and nozzle.

However, in other embodiments that utilize fluids that have a very low temperature when compared to an ambient temperature (such as with cryogentic fluids like LNG), the nozzle-side poppet 220 may substantially seal the nozzle-side architecture 101 but also feature a controlled leak so as to alleviate pressure that may build up as the fluid may begin to expand when heated (for example, as the cryogentic fluid begins to rise in temperature toward the ambient temperature). Thus, in the context of a fuel delivery system 10, the nozzle-side hose 40 and nozzle (not shown) may be pressurized initially, but may experience increased pressurization (e.g., due to expanding fluid with rising temperatures). Accordingly, a controlled leak via the nozzle-side poppet 220 may be used to prevent over-pressurization of the nozzle-side hose 40, nozzle-side architecture 101 and nozzle as well.

After a break-away body 103 fails, the break-away coupling 100 may be serviced to replace the break-away body 103 so that the break-away coupling 100 may be used again. For example, the break-away body 103 may be coupled with the nozzle-side architecture 101 and dispenser-side architecture 102 via corresponding threads 355, 360, which allows the broken portions of the break-away body 103 to be unscrewed from the dispenser and nozzle-size architecture 101, 102 and allows a replacement break-away body 103 to be screwed into the dispenser and nozzle-size architecture 101, 102.

Additionally, although specific embodiments have been illustrated and described herein, it will be appreciated by those of ordinary skill in the art and others, that a wide variety of alternate and/or equivalent implementations may be substituted for the specific embodiment shown and described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

1. A coupling, comprising:
a first end configured to engage a fluid dispensing nozzle;
a second end configured to engage a fluid dispensing system
a break-away body disposed between the first end and the second end; and
a sensor configured to determine if the first end is separated from the second end.

2. The coupling of claim 1, wherein the break-away body comprises a junction point of a first portion and a second portion suited to break when a suitable force is applied to the junction.

3. The coupling of claim 2, wherein the junction comprises one of the group including: a weld junction, an adhesive junction, a magnetic junction, and a friction fitting junction.

4. The coupling of claim 1, wherein the sensor is disposed on the first end of the coupling.

5. The coupling of claim 1, wherein the sensor comprises a pressure sensor suited to provide a signal indicating pressure at the first end.

6. The coupling of claim 1, wherein the sensor comprises an electric sensor configured to provide a signal indicating coupling of the first end to the second end.

7. The coupling of claim 1, wherein the sensor comprises a mechanical sensor having a pin configured to indicate coupling of the first end to the second end.

8. The coupling of claim 1, further comprising a poppet disposed in the first end and configured to arrest the flow of fluid through the first end if the first end is separated from the second end.

9. The coupling of claim 1, further comprising a poppet disposed in the second end and configured to arrest the flow of fluid through the second end if the first end is separated from the second end.

10. The coupling of claim 9, wherein the poppet is further configured to allow controlled leakage after arresting the flow of fluid in response to the first end being separated from the second end.

11. The coupling of claim 1, further comprising components configured for handling liquid natural gas and low temperatures.

12. The coupling of claim 1, further comprising
a first shaft having a first central axis aligned with a central axis of the first end; and
a second shaft having a second central axis, the second shaft coupled to the first shaft such that the second central axis is set at a non-zero angle to the first central axis.

13. The coupling of claim 12, wherein the angle is such that a force applied to the second shaft is substantially transferred to the first shaft to place the force substantially upon the break-away body.

14. A fuel delivery system, comprising:
a fuel dispensing tank;
a fuel dispensing line coupled to the fuel dispensing talked and configured to deliver fuel to a vehicular fuel tank; and
a break-away coupling in the fuel dispensing line, including:
a first end configured to engage a fluid dispensing nozzle;
a second end configured to engage a fluid dispensing system
a break-away body disposed between the first end and the second end; and
a sensor plug configured to determine if the first end is separated from the second end.

15. The fuel dispensing system of claim 14, wherein the fuel comprises liquid natural gas.

16. The fuel dispensing system of claim 14, wherein the first end further comprises:
a first shaft having a first central axis aligned with a central axis of the first end; and
a second shaft having a second central axis, the second shaft coupled to the first shaft such that the second central axis is set at a non-zero angle to the first central axis.

17. The fuel dispensing system of claim 14, wherein the sensor comprises a pressure sensor suited to provide a signal indicating pressure at the first end.

18. A method, comprising:
dispensing a liquid from a first location to a second location though a coupling having a first end and a second end;
sensing separation of the first end from the second end; and
arresting the dispensing in response to the sensing.

19. The method of claim 18, further comprising engaging a poppet at each of the first and second ends after sensing separation of the first end from the second end.

20. The method of claim 18, wherein the separation is caused by a force applied to one of the ends.
